(19) United States
(12) Patent Application Publication
(10) Pub. No.: US 2025/0216016 A1
(43) Pub. Date: Jul. 3, 2025

(54) Small Diameter Pipe Camera Inspection System

(71) Applicant: Northeast Gas Association, Parsippany, NJ (US)

(72) Inventors: Paul Laursen, North York (CA); Jonathan Wat, Toronto (CA); Marco Anthony Nitti, Richmond Hill (CA); Xiaotian Yi, Richmond Hill (CA); Natan Kohon, Toronto (CA); Kibo Yaoxing Luo, Oakville (CA)

(73) Assignee: Northeast Gas Association, Parsippany, NJ (US)

(21) Appl. No.: 19/003,396

(22) Filed: Dec. 27, 2024

Related U.S. Application Data
(60) Provisional application No. 63/615,892, filed on Dec. 29, 2023.

(51) Int. Cl. F16L 55/38; F16L 55/46; F16L 55/48; G01M 3/00; G01N 21/954

(52) U.S. Cl. CPC F16L 55/38; F16L 55/46; F16L 55/48; G01M 3/005; G01N 21/954; G01N 2021/9548

(57) ABSTRACT

A small diameter pipe inspection system for capturing images of an inner wall of a pipe into which the pipe inspection system is travelling, using an on-board camera, a cup assembly with petals operably interconnected so as to be expandable to a deployment position in order to rest against an inner wall of a pipe within which the pipe inspection system is located, and to be retractable to a collapsed position in order to allow a gap with respect to the inner wall of the pipe, whereby, when the petals are expanded to the deployment position, the cup assembly blocks passage of a gas flowing through the pipe, increasing pressure on the petals so as to cause the camera system to travel along the pipe towards a lower pressure in the pipe in the direction of downstream gas flow.

### BACKGROUND OF THE INVENTION

A non-renewable fossil fuel energy source, natural gas (sometimes called fossil gas, methane gas, or simply gas) is formed underground when layers of organic marine microorganisms decompose under anaerobic conditions of intense heat over millions of years. This naturally occurring gas comprises a mixture of mostly methane, together with trace gases such as carbon dioxide, nitrogen, hydrogen sulfide and helium. This gas is formed and is found in underground geological formations.

In use, because methane is colorless and odorless, an odorizing agent such as mercaptan (which smells like sulfur or rotten eggs) is added to it for safety so that leaks can hopefully be readily detected.

Natural gas can be burned for heating, cooking, electricity generation, as a chemical feedstock in plastic manufacturing, and as a fuel for vehicles.

Methane comprises 70-90 or higher percent of natural gas. Because of this, the greatest risk for natural gas pipelines is associated with fires or explosions caused by ignition of the natural gas, with risks of significant property damage and injuries or death.

It is an object of the present invention to eliminate or minimize such risks by providing a safety inspection system for relatively small diameter pipes (such as, but not limited to 2-inch diameter pipes), that is helpful in finding and identifying pipeline defects that may result in the undesirable leaks or releases of gas.

By way of example, in the U.S. there is a complex nationwide system of pipelines that carries natural gas used daily for millions for their consumer and commercial needs. Domestic natural gas markets are regulated at least in part by the Federal Energy Regulatory System. In fact, most of the world's natural gas is delivered by pipeline.

Pipelines can be characterized as interstate or intrastate, similar to our highway systems. Pipelines traverse state boundaries and, in some cases, clear across the country. When natural gas arrives through large pipelines at the locations where it will be used, it flows into smaller diameter pipelines called “mains” and then into smaller “service lines” that go directly to homes or buildings.

Natural gas flows through transmission pipelines under pressures between 5,000 to 14,000 kilopascals. Compressor stations ensure consistent natural gas flows through the system by establishing pressures from higher to lower along pipelines. The transport of natural gas through pipelines can be difficult because friction in the pipes will cause the gas to heat up.

It is not easy to store and transport natural gas under pressure. Natural gas, which is lighter than ambient air, is commonly held in underground facilities such as depleted reservoirs, gas fields, aquifers, and salt cavern formations. Such gases are also stored above-ground in liquid or gaseous form in tanks.

Distribution pipelines are relatively small lines that represent the final link in the chain of oil and gas development, which move gas products in gaseous form, not liquid form, from final transportation points along transmission pipelines to homes, businesses and industrial facilities.

The piping that carries natural gas that the present invention is concerned with is polyethylene (PE) piping. This pipe composition comprises a mixture of polymers and ethylene of different grades. The most commonly material used for gas piping is medium-density polyethylene (MDPE). Benefits of using this material include its relatively light weight, its weather-resistance, its resistance to relatively higher-pressure levels, its resistance to corrosion, its affordability, and its ease of transport. Natural gas pipelines are typically designed to have a useful life of about 50 years.48 inches,

Most principal or mainline natural gas pipelines are 16 to 48 inches in diameter and are buried under the ground. Lateral pipelines, which deliver natural gas to or from the mainline are typically between 6 and 16 inches in diameter. Flow rate velocities of 5 to 12 m³/sec.

According to the U.S. Department of Transportation, pipelines are the safest, most reliable and cost-effective means of transporting energy products over long distances, such as natural gas. That said, a likely scenario for a natural gas pipeline accident involves leakage from a hole or opening in the pipeline. Such a leak may cause the leak to ignite immediately, or it may result in delayed ignition of a gas cloud.

Unlike with relatively larger diameter pipes that carry natural gas, where robotic systems may be deployed to wirelessly and remotely inspect and evaluate the condition of piping, the very issue of scale presents unique challenges to those wishing to effectively, economically, reliably, and accurately provide visual data of the condition of small pipes.

Tools exist for the inspection of plastic (PE) pipe. These tools focus upon and are used for water, sewer and natural gas piping. Among such tools is at least one system that includes a camera that is inserted into piping via launching technology under live conditions, where natural gas is flowing in the piping. A push rod transmits forces to move the camera among locations, and a relatively heavy power line is used to provide power to the camera. The camera provides the user with live video feed to the system's operator.

Major disadvantages associated with the aforementioned prior art include: (a) as the assembly is manually pushed and moved within a pipe, internal pipe surfaces are scraped and damaged, leading to the very undesirable situation sought to be discovered; and (b) there is a limited range of approximately 150 feet from the launching point, due to the relatively heavy, friction generating, push rod range limitations. Thus, such prior art attempts to provide needed information cause and include undesirable, destructive characteristics. An example of such prior art includes the Hathorn inspection camera system, described at www.hathorncorp.com.

It is an object of a preferred embodiment of the present invention to provide a pipe camera inspection system for use with and in small (e.g., 2-inch) diameter pipelines which carry natural gas.

The present invention contemplates instant pipe camera inspection systems which are capable of use with pipes of a variety of diameters.

### SUMMARY OF THE INVENTION

The present invention, in preferred embodiments thereof, provides a novel natural gas-carrying pipeline visual-only camera safety inspection system, scalable such that it is capable of use with and in relatively small diameter pipelines (e.g. 2-inch diameter pipelines), as well as with piping of smaller and larger diameter sizes (such as, by way of example only, 1-inch, 1.5-inch, or 4-inch diameter pipes). The term visual-only is used herein to suggest that only camera-ready technology is preferred in and described for this system. Other technologies, including sensing technologies, that are used in relatively larger diameter pipe inspection systems are not necessarily used in the preferred embodiment of the present invention, although they may be added for certain applications if desired. While 2-inch piping is used as an example in this specification, this should not be misinterpreted as a limitation of the environment within which the invention is capable of operating in.

The present invention provides the user the ability to inspect small diameter pipelines in order to locate with precision, identify, and inspect for leaks, defects, pipe tees, bends, butt fusion welds, and/or anomalies (abnormalities) that do or may have the potential to create safety hazards.

Thus, provided is a pipe camera inspection system for use with relatively small diameter natural gas pipelines, such as 2-inch diameter for example. The camera system includes, in combination, a housing capable of holding the required components of the present invention; at least one battery for providing power needed by the present invention; a printed circuit board (PCB) held within the housing; a camera (such as a digital sensor array known in the art) held within the housing; an LED light-emitting ring for providing light needed by the camera; a cup assembly with various flower-like petals shaped to capture natural gas flow to move the camera system downstream in the direction of gas flow; a tether provided on a spool, or the like, secured to an upstream side of the housing; the tether having a known length and known graduations and indicia; and a launcher for enabling a user of this system to both unspool and pay out tether in measurable lengths due to forces of gas against the cup-like member, and to rewind the tether, to permit the user to correlate images captured by the camera with the exact location of the camera in the pipeline when the images are captured, the length of paid-out tether thereby enabling the identification of gas-escaping pipe defects and an accurate location of such defects to enable repair or replacement of defective piping.

In use, the present invention is a pipe camera inspection system for use with relatively small diameter natural gas pipelines, in which a camera in a housing is attached to a relatively light tether, the tether facilitating camera travel of relatively long distances within pipes of relatively small diameter, controlling the magnitude of the distances by adjusting pressure and flow rates of natural gas within piping carrying such gas, deploying the camera system by means of a launcher system integral with the piping, providing self-propulsion of the camera within the pipes by the flow of natural gas against a deployable cup integral with a rear part of the housing, a cup-shaped apparatus formed with a predetermined number of deployable petal-like elements, that are preferably covered with a relatively low friction layer of predetermined material that generates very little friction with and against inner surfaces of the piping, whereby, in operation, when the camera is deployed within the piping, the petals are deployed via expansion so as to touch, without damaging, pipe surfaces, thereby capturing forces associated with gas flow, with resulting propulsive forces upon the cup, and camera and its supporting structure in the direction of downstream gas flow, the magnitude of these propulsive forces being dependent upon and is a function of gas pressure and gas flow rates within the piping, the camera capturing images throughout this deployment mode, retrieval of the camera and the system being facilitated by collapsing of the petals which is caused, in turn, by pulling tension forces applied through the tether, against gas flow forces, and controlling pressure and gas flow rates needed to provide desirable camera ranges by means of (a) the introduction of additional gas through the launcher into the piping at relatively higher speeds; and/or (b) insertion of a negative pressure (vacuum) system downstream of the launching point, to help generate relatively higher gas flow rates within the piping.

The present invention does away with the use of push-rods and a live camera feed. Instead, the present invention stores images collected by the deployed camera. These stored images can be downloaded for review by a system operator at the end of an inspection run. An advantage of this approach is the ability to use and maintain relatively lighter weight tethers, for longer ranges.

### BRIEF DESCRIPTION OF THE DRAWING

FIG. 1 is an illustration of a preferred embodiment camera system of the present invention.

FIG. 2 is an exploded view of the preferred embodiment of FIG. 1.

FIG. 3 is a partial exploded view of the preferred embodiment of FIG. 1.

FIG. 4 is an end view of the camera system of the preferred embodiment of FIG. 1.

FIG. 5 is a left-side elevation view of the preferred embodiment launcher of the present invention, illustrating the manual hand crank used to pay out and retrieve a tether line.

FIG. 6 is a side view of the preferred embodiment launcher of FIG. 5.

FIG. 7 is a perspective view of the internal assembly of the preferred embodiment launcher.

FIG. 8 is a side view of the internal assembly of the preferred embodiment launcher.

FIG. 9 is a top view of the preferred embodiment launcher.

FIG. 10 is an exploded view of the internal assembly of the preferred embodiment launcher.

FIG. 11 is an exploded view of an alternative launcher.

FIG. 12 is a top view of the alternative launcher of FIG. 11.

### DETAILED DESCRIPTION OF THE INVENTION

The present invention includes, without limitation, a system wherein a camera housing is attached to a relatively light tether. The tether facilitates system travel of relatively long distances within pipes of relatively small diameter. Ranges of 1000 feet or more can be realized, depending upon pressure and flow rates of natural gas within piping carrying such gas.

The camera system is deployed by means of a launcher system integral with the piping. The camera system is self-propelled within the pipes by the flow of natural gas against a deployable cup assembly integral with a rear part of the camera housing.

Much like a flower with petals, the cup assembly has a predetermined number of deployable and retractable plastic petals that are preferably covered with a relatively low friction layer of special material that generates very little friction with and against inner surfaces of the piping.

In operation, when the camera system is deployed within the piping, the petals are deployed via expansion so as to touch, without damaging, pipe surfaces, thereby capturing forces associated with gas flow, with resulting propulsive forces upon the cup, and the camera housing in the direction of downstream gas flow. The magnitude of these propulsive forces is dependent upon and is a function of gas pressure and gas flow rates within the piping. The camera captures images throughout this deployment mode.

Retrieval of the camera system is facilitated by collapsing of the petals which is caused, in turn, by pulling tension forces applied through the tether, against the gas flow forces. This invention facilitates camera deployment of 1000 feet or more from the camera deployment point.

In accordance with the present invention, pressure and gas flow rates needed to provide desirable camera ranges are controllable as follows: (a) the introduction of additional gas through the launcher into the piping at relatively higher speeds; and (b) insertion of a negative pressure (vacuum) system downstream of the launching point, to help generate relatively higher gas flow rates within the piping.

The present invention does away with the use of push-rods and a live camera feed. Instead, the present invention stores images collected by the deployed camera. These stored images can be downloaded for review by a system operator at the end of an inspection run. An advantage of this approach is the ability to use and maintain relatively lighter weight tethers, for longer ranges.

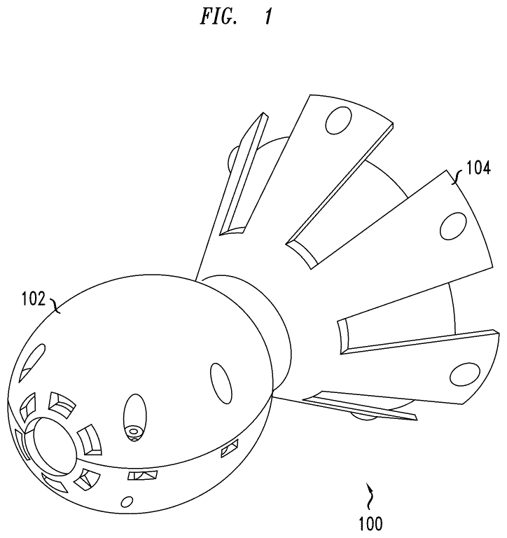

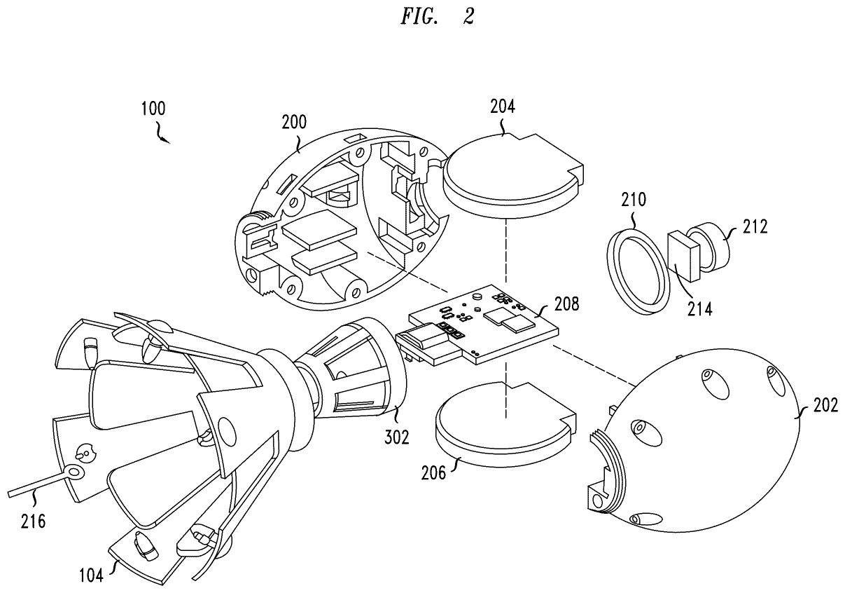

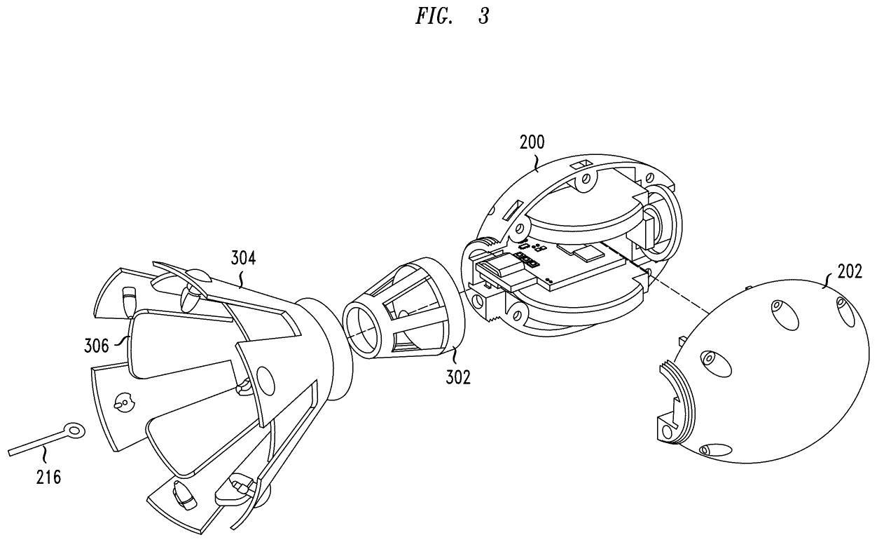

Thus, with reference to FIG. 1, shown is an illustration of a preferred embodiment camera system 100 of the present invention, and in particular illustrated is a housing 102 coupled to a flow cup assembly 104 used to move the housing 102 downstream against the tensile force at the rear tether (shown in FIGS. 2, 3).

FIG. 2 is an exploded view of the preferred embodiment of FIG. 1, and FIG. 3 is a partial exploded view of the preferred embodiment of FIG. 1. Shown is the camera system 100 with a housing 102 that is assembled from a left housing section 200 and a right housing section 202. A pair of batteries 204, 206 are also shown, but more or less than these two batteries may be used as may be required. A printed circuit board 208 provides various electronic components as known in the art, for example for controlling operation of a camera 214, a lens 212, and an LED ring 210. Digital storage is also provided on the PC board 208 for storing images of the pipe wall that are captured by the camera 214 for later downloading and analysis.

A tether 216 is also shown, which is connected to the cup assembly 104 and used to control deployment of the petals 304, 306 in the cup assembly 104 as well as retrieval of the camera system 100 back through the pipe in which it has been deployed. Ring feature 302 is used to couple the assembled housing 102 to the cup assembly 104.

As shown in FIGS. 2 and 3, the cup assembly 104 is made from several petals, which in the preferred embodiment include the outer petals 304 and the inner petals 306. That is, the cup assembly 104 includes a predetermined number of these deployable and retractable plastic petals 304, 306 that are preferably covered with a relatively low friction layer of special material that generates very little friction with and against inner surfaces of the pipe.

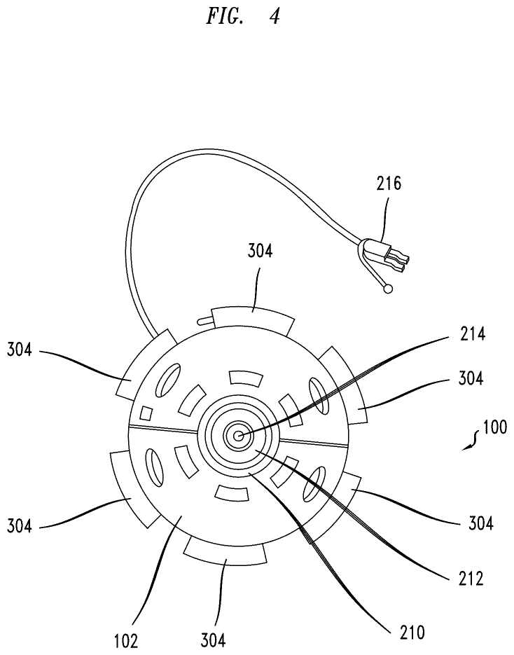

FIG. 4 is an end view of the camera system 100, in which the housing 102 contains the camera 214 covered by the lens 212, surrounded by the LED ring 210 for illumination of the pipe walls, and wherein the outer edges of the outer petals 304 may be seen in the deployed position.

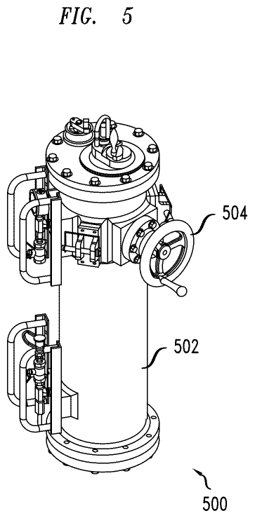

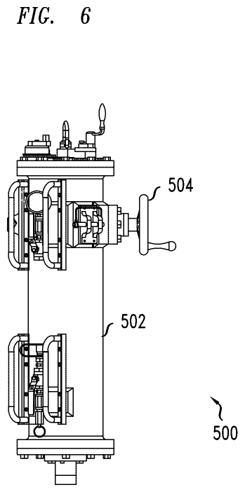

FIG. 5 is a left-side elevation view of the preferred embodiment launcher 500 of the present invention, illustrating the launcher housing 502 and the manual hand crank 504 used to pay out and retrieve a tether line 216 connected to the launcher 500. FIG. 6 is a side view of the launcher 500.

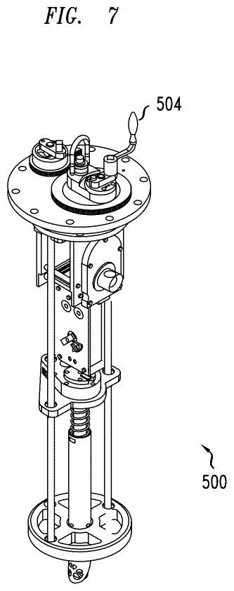

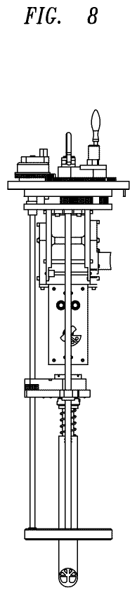

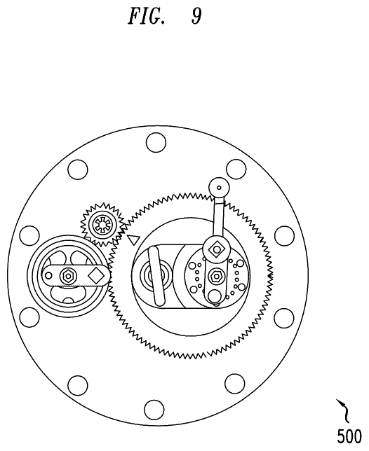

FIG. 7 is a perspective view of the internal assembly of the launcher 500, FIG. 8 is a side view of the internal assembly of the launcher 500, and FIG. 9 is a top view of the launcher 500.

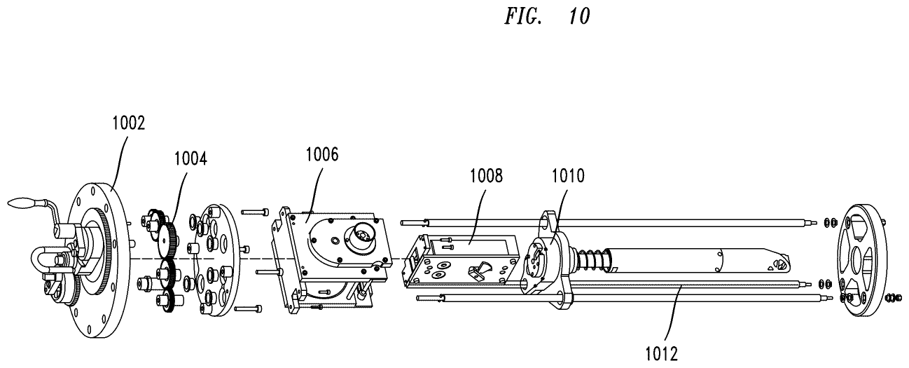

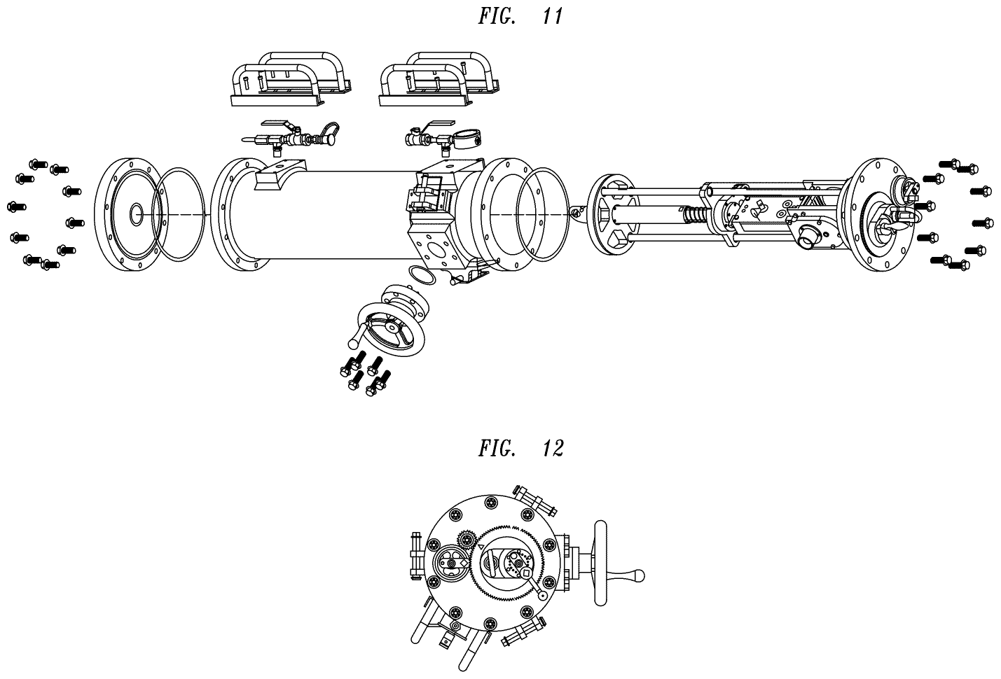

With further reference to FIG. 10, shown is an exploded view of the internal assembly of the launcher 500. In particular, shown are the following components: a flange assembly 1002, which contains the hand crank 504, a gear assembly 1004, a spool assembly 1006 for spooling the tether 216 in or out, a spool odometry unit 1008 for tracking deployment of the tether, a scoop carrier assembly 1010, and a square orientation drive shaft 1012.

In operation, the camera system is placed within the pipe, the camera system comprising a housing, a camera comprising a digital camera sensor array within the housing; a printed circuit board comprising control circuitry for controlling operation of the camera and storing images captured by the camera, a battery for providing operating power to the printed circuit board and the camera, and a cup assembly coupled to the housing, the cup assembly comprising at least one set of petals operably interconnected so as to be expandable to a deployment position in order to rest against an inner wall of a pipe within which the pipe inspection system is located, and to be retractable to a collapsed position in order to allow a gap with respect to the inner wall of the pipe. The petals are expanded to the deployment position, so that a gas flow is captured within the pipe so as to exert pressure against the petals and urge the camera system to travel along the pipe. The tether has position markings indicative of a length the tether has been deployed while the camera system is travelling within the pipe. Images within the pipe as the camera system travels within the pipe, and a position marker is captured that is associated with the capturing of an image along the pipe, whereby the location of the pipe inspection system when an image is captured by the camera within the pipe may be determined.

Subsequently, the tether is operated to move the petals to the collapsed position to enable the camera system to cease travel along the pipe, and the tether is operated to retract the camera system back out of the pipe.

What is claimed is:

1. A small diameter pipe inspection system for capturing images of an inner wall of a pipe into which the pipe inspection system is travelling, the pipe inspection system comprising a camera system comprising
a housing;
a camera comprising a digital camera sensor array within the housing;
a printed circuit board comprising control circuitry for controlling operation of the camera and storing images captured by the camera;
a battery for providing operating power to the printed circuit board and the camera;
a cup assembly coupled to the housing, the cup assembly comprising at least one set of petals operably interconnected so as to be expandable to a deployment position in order to rest against an inner wall of a pipe within which the pipe inspection system is located, and to be retractable to a collapsed position in order to allow a gap with respect to the inner wall of the pipe;
whereby, when the petals are expanded to the deployment position, the cup assembly blocks passage of a gas flowing through the pipe, increasing pressure on the petals so as to cause the camera system to travel along the pipe towards a lower pressure in the pipe in the direction of downstream gas flow, and when the petals are retracted to the collapsed position, the cup assembly allows passage of the gas flowing through the pipe, decreasing pressure on the petals so as to cause the camera system to cease travel along the pipe.

2. The pipe inspection system of claim 1 further comprising a tether operatively coupled to the housing, the tether comprising position markings indicative of a length the tether has been deployed while the camera system is travelling within the pipe.

3. The pipe inspection system of claim 2 wherein a position marker is captured associated with capturing of an image along the pipe, whereby the location of the pipe inspection system when an image is captured by the camera within the pipe may be determined.

4. The pipe inspection system of claim 3 wherein the tether may be used to retrieve the camera system from within the pipe.

5. The pipe inspection system of claim 1 wherein the petals are plastic and covered with a relatively low friction layer of material.

6. The pipe inspection system of claim 1 wherein the tether controls deployment of the petals.

7. The pipe inspection system of claim 6 further comprising a launcher assembly.

8. The pipe inspection system of claim 7 wherein the launcher assembly introduces additional gas into the pipe at relatively higher speeds.

9. The pipe inspection system of claim 8 wherein the launcher comprises a hand crank for pay out and retrieval of the tether.

10. A method of inspecting a small diameter gas-carrying pipe, comprising the steps of:
placing a camera system within the pipe, the camera system comprising a housing, a camera comprising a digital camera sensor array within the housing; a printed circuit board comprising control circuitry for controlling operation of the camera and storing images captured by the camera, a battery for providing operating power to the printed circuit board and the camera, and a cup assembly coupled to the housing, the cup assembly comprising at least one set of petals operably interconnected so as to be expandable to a deployment position in order to rest against an inner wall of a pipe within which the pipe inspection system is located, and to be retractable to a collapsed position in order to allow a gap with respect to the inner wall of the pipe;
expanding the petals to the deployment position,
capturing a gas flow within the pipe so as to exert pressure against the petals and urge the camera system to travel along the pipe,
unwinding a tether operatively coupled to the housing, the tether comprising position markings indicative of a length the tether has been deployed while the camera system is travelling within the pipe,
capturing images within the pipe as the camera system travels within the pipe, and
capturing a position marker associated with the capturing of an image along the pipe, whereby the location of the pipe inspection system when an image is captured by the camera within the pipe may be determined.

11. The method of claim 10 further comprising the step of
retracting the petals to the collapsed position to enable the camera system to cease travel along the pipe.

12. The method of claim 11 further comprising the step of winding the tether to retract the camera system back out of the pipe.

13. The method of claim 12 wherein the tether controls deployment of the petals.
